(19) United States
(12) Patent Application Publication
(10) Pub. No.: US 2015/0228420 A1
(43) Pub. Date: Aug. 13, 2015

(54) PROTECTIVE COVER FOR REMOTE CONTROL

(71) Applicants: John C. McDaniel, Worcester, MA (US); Anthony J. Paravano, Uxbridge, MA (US)

(72) Inventors: John C. McDaniel, Worcester, MA (US); Anthony J. Paravano, Uxbridge, MA (US)

(21) Appl. No.: 14/618,841

(22) Filed: Feb. 10, 2015

Related U.S. Application Data
(60) Provisional application No. 61/938,405, filed on Feb. 11, 2014.

(51) Int. Cl. H01H 9/02; B65D 25/10

(52) U.S. Cl. CPC H01H 9/0242; B65D 25/10

(57) ABSTRACT

A protective cover is provided for a remote control device of the type having a plurality of buttons designed to be pressed to perform operations on a remote apparatus. The protective cover includes a rigid skin configured to be secured to the remote control to cover a front of the remote control. The rigid skin includes openings formed therein to selectively reveal certain buttons of the remote control device to be pressed by an operator of the remote control device. The rigid skin is configured to prevent covered buttons from being pressed by the operator.

### CROSS-REFERENCE TO RELATED APPLICATIONS

This application claims priority to U.S. Provisional Patent Application No. 61/938,405 filed Feb. 11, 2014, entitled PROTECTIVE COVER FOR REMOTE CONTROL, which is incorporated by reference herein in its entirety.

### BACKGROUND OF THE DISCLOSURE

1. Field of the Invention

This disclosure relates generally to accessories for remote control devices, and more particularly to a protective cover that is designed to prevent buttons of a remote control from being inadvertently pressed by its user.

2. Description of the Prior Art

Television viewers of all ages frequently press the wrong button or buttons on their remote control, which may cause the television or video screen to immediately reset or communicate with a source not intended by the operator of the remote control. One minute, a viewer is happily watching a certain station and the next minute, after inadvertently or unintentionally pressing a wrong button on the remote control, which can have fifty or more buttons, the viewer has manipulated the system so that the viewer is unable to access the station. Often, the result is that the desired programming is no longer able to be watched without intervention by others. This is a very common problem, especially among seniors, toddlers and those who are technically inept.

FIG. 1 illustrates an exemplary remote control device 10 to remotely control a remote device, such as a cable box, which is sometimes referred to as a set top box. As shown, the remote control device includes a plurality of buttons, each indicated 12, which are provided to manipulate the remote device. The exemplary remote control device shown in FIG. includes fifty-three buttons that are designed to operate the cable box and the television. The remote control device can also be used to operate any type of electronic apparatus, such as televisions, DVD players, tuners, and the like.

### SUMMARY OF THE DISCLOSURE

One aspect of the present disclosure is directed to a protective cover for a remote control device of the type having a plurality of buttons designed to be pressed to perform operations on a remote apparatus. In one embodiment, the protective cover comprises a rigid skin configured to be secured to the remote control to cover a front of the remote control. The rigid skin includes openings formed therein to selectively reveal certain buttons of the remote control device to be pressed by an operator of the remote control device. The rigid skin is configured to prevent covered buttons from being pressed by the operator.

Embodiments of the protective cover further may include fabricating the rigid skin from thermoplastic polymeric material. The rigid skin may be fabricated from acrylonitrile butadiene styrene. The remote apparatus may be a set top box. The openings may be configured to provide access to frequently used buttons, including ON/OFF, CHANNEL UP/DOWN, VOLUME UP/DOWN, GUIDE, LAST, MENU and/or MUTE. The rigid skin may be fabricated from a robust thermoplastic engineered resin, polycarbonate, or another resin in the same family of plastics. The rigid skin may include at least one side having at least one connector that is designed to engage an edge or a seam of the remote control device. The at least one connector may include a snap-fit connector having an edge that is designed to engage the edge of the remote control device. The rigid skin may be configured with perforations around select buttons of the remote control device to enable the operator to remove a portion of the rigid skin to provide access for a particular button or buttons. The rigid skin may include a front that conforms to the front of the remote control device and sides that conform to sides of the remote control device. The rigid skin may include at least one side having at least one connector that is designed to engage an edge or a seam of the remote control device. The at least one connector may include a snap-fit connector having an edge that is designed to engage the edge of the remote control device. The front of the rigid skin may be molded to show locations of buttons of the remote control device covered by the rigid skin.

Another aspect of the disclosure is directed to a protective cover comprising a rigid skin configured to be secured to the remote control to cover a front of the remote control. The rigid skin includes a front having openings formed therein to selectively reveal certain buttons of the remote control device to be pressed by an operator of the remote control device. The rigid skin is configured to prevent covered buttons from being pressed by the operator. The rigid skin further includes sides that conform to sides of the remote control device, with the sides being configured to releasably secure the rigid skin to the remote control device.

Embodiments of the protective cover further may include fabricating the rigid skin from thermoplastic polymeric material. The rigid skin may be fabricated from acrylonitrile butadiene styrene. The sides of the rigid skin may have has at least one connector that is designed to engage an edge or a seam of the remote control device. The at least one connector may have an edge that is designed to engage the edge or the seam of the remote control device. The front of the rigid skin may be molded to show locations of buttons of the remote control device covered by the rigid skin. The remote apparatus may be a set top box, and the openings of the front of the rigid skin may be configured to provide access to frequently used buttons, such as ON/OFF, CHANNEL UP/DOWN, VOLUME UP/DOWN, GUIDE, LAST, MENU and/or MUTE.

The protective cover of embodiments of the present disclosure is designed to selectively prevent a person from inadvertently pressing buttons on a remote control, such as a remote control for an entertainment system.

Note that each of the different features, techniques, configurations, etc. discussed in this disclosure can be executed independently or in combination. Accordingly, the present disclosure can be embodied and viewed in many different ways.

Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the disclosure, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the disclosure, as illustrated in the accompanying drawings in which like reference characters refer to the same parts throughout the different views. The drawings are not necessarily to scale, emphasis instead being placed upon illustrating the principles of the invention.

FIG. 1 is a perspective view of a remote control device;

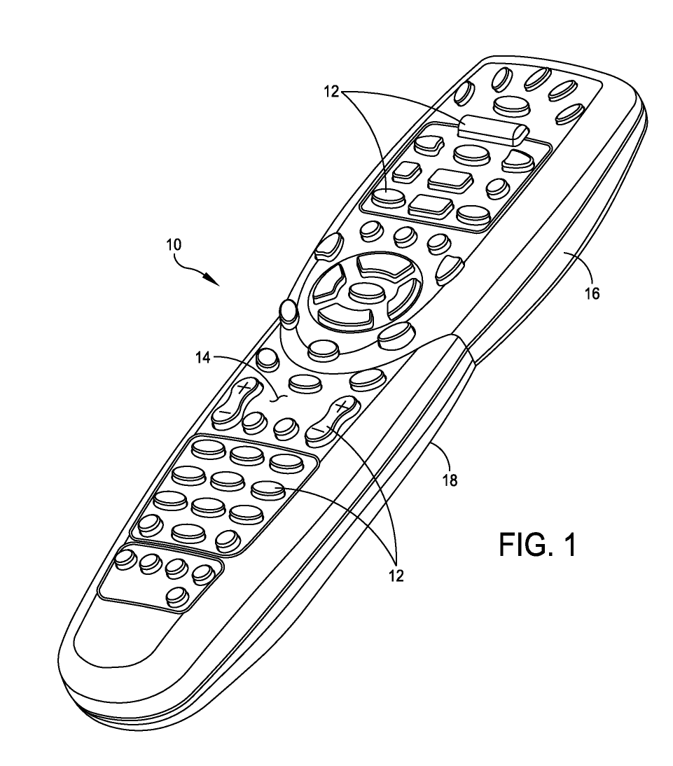

FIG. 2 is a perspective view of a protective cover of embodiments of the present disclosure applied to the remote control device;

FIG. 3 is a perspective view of the protective cover being separated from the remote control device;

FIG. 4 is a top plan view of the protective cover;

FIG. 5 is a side view of the protective cover;

FIG. 6 is an end view of the protective cover; and

FIGS. 7-10 are perspective views of protective covers of alternative embodiments of the present disclosure.

### DETAILED DESCRIPTION OF PREFERRED EMBODIMENTS

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The concepts disclosed herein are capable of other embodiments and of being practiced or being carried out in various ways. Also the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

A protective cover made of engineered thermoplastic designed to be fitted onto a front or the top of a held-held set top box remote control or television remote control, and designed to prevent users from being able to press unwanted button(s) on their remote control in error and interrupt the viewing of desired programming. The protective cover fits onto the remote control unit like a “second skin” and follows the contours of the remote control. As a result, the remote control unit having the protective cover is comfortable in the user's hand. A different injection mold is required for each remote control model for which the device is marketed. The device is configured to mechanically block access to infrequently used buttons on the remote control. Frequently used buttons are not obfuscated or blocked in any form or manner by the protective cover, and remain open and accessible to the viewer without restriction. The protective cover is easily removable, and its removal returns the remote control unit to its original, unaltered condition.

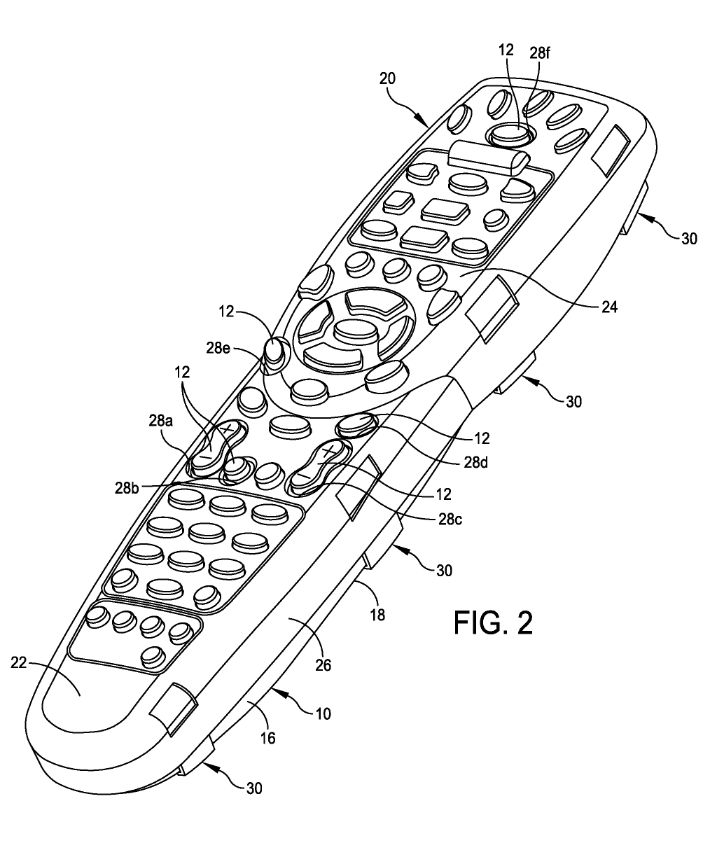

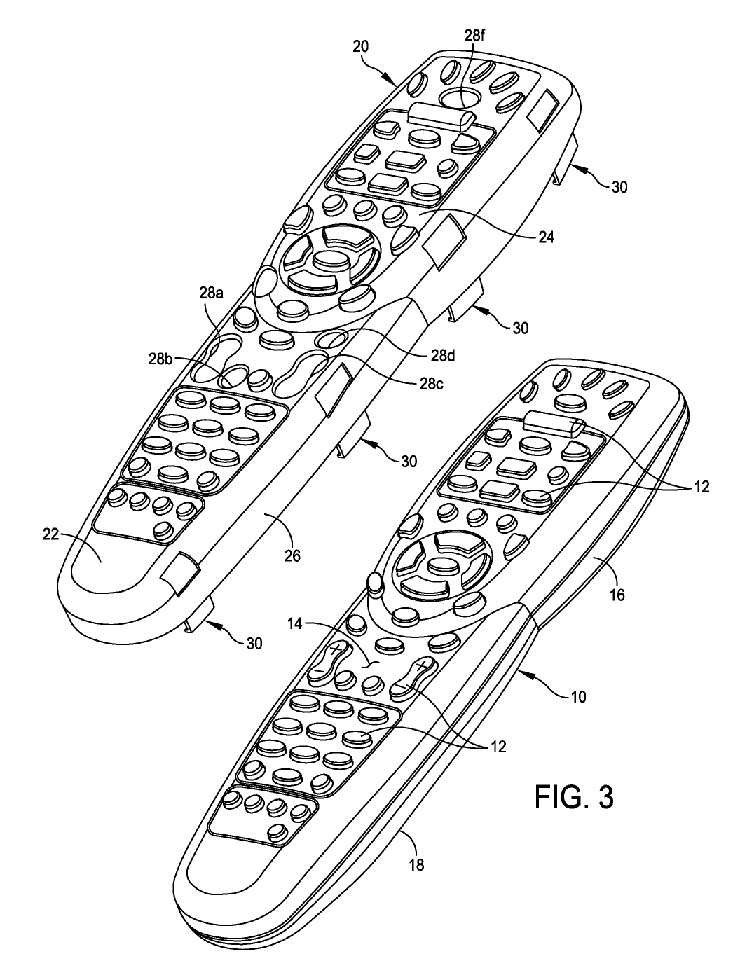

Referring to the drawings, and more particularly to FIGS. 2 and 3, a protective cover of embodiments of the present disclosure is generally indicated at 20. As shown, the protective cover 20 is designed to form fit over the remote control device 10. Specifically, the protective cover 20 includes a rigid skin 22 that is configured to be secured to the remote control device 10 to overlay and protect a front 14 of the remote control device having buttons 12. The rigid skin 22 includes a front wall 24 that conforms to the front 14 of the remote control device 10 and a contiguous side wall 26 that extends generally perpendicularly from the front wall and conforms to sides 16 of the remote control device. In another embodiment, the contiguous side wall 26 can be configured as separate walls that extend from the front wall 24 of the rigid skin 22. The front wall 24 and the side wall 26 of the rigid skin 22 form fit over the remote control device 10, with the size and shape of the rigid skin being selected and configured depending on the particular size and shape of the remote control device.

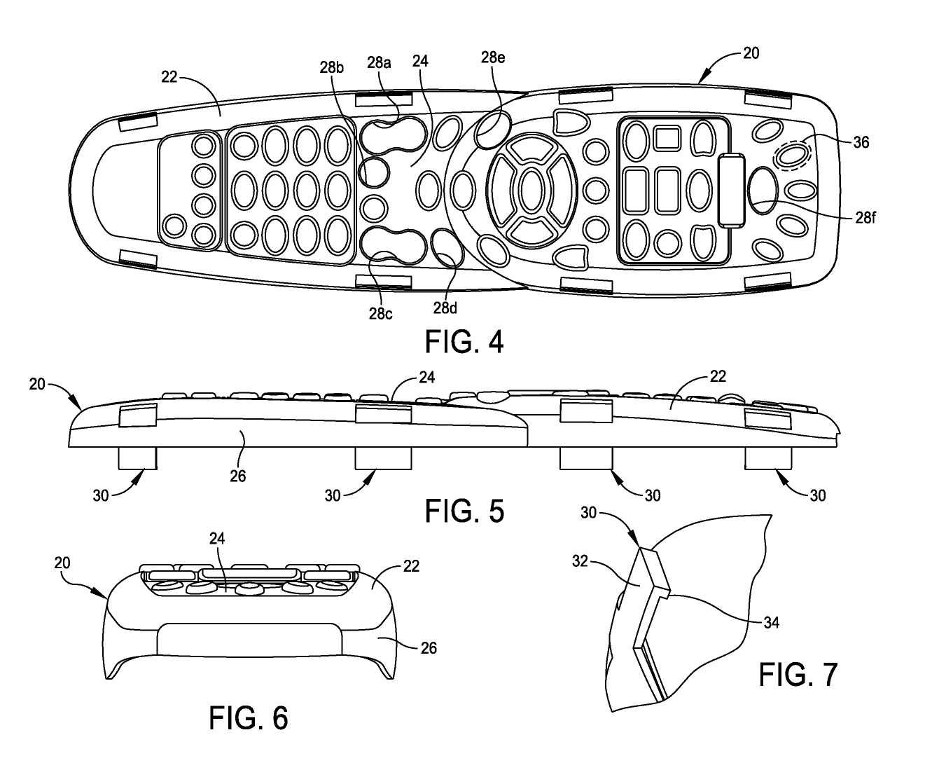

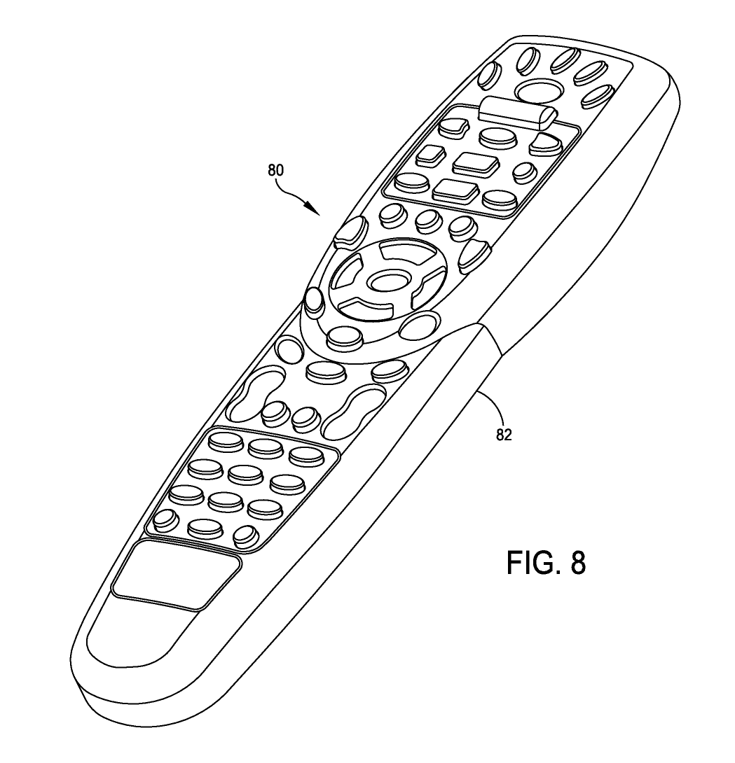

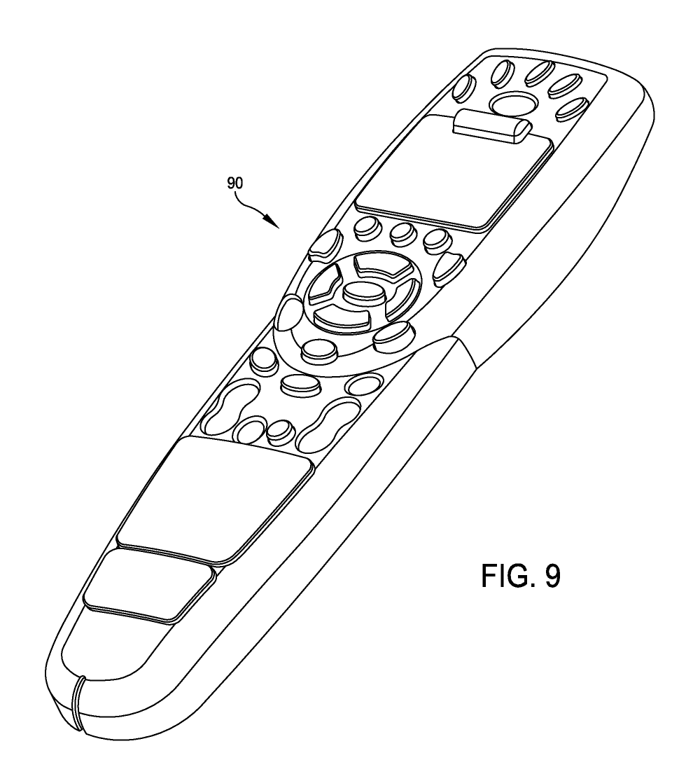

Referring additionally to FIGS. 4-6, the front wall 24 of the rigid skin 22 has openings, 28a, 28b, 28c, 28d, 28e, 28f formed therein to selectively reveal certain buttons 12 of the remote control device 10 to be pressed by an operator of the remote control device. Although six openings 28a-28f are illustrated in FIGS. 2, 3 and 4, the rigid skin 22 may be configured to have more or less openings to reveal more or less buttons 12 of the remote control device 10. The rigid skin 22 is molded to show locations of buttons 12 of the remote control device 10 covered by the rigid skin. The front wall 24 of the rigid skin 22 is configured to prevent covered buttons from being pressed by the operator. Thus, a person operating the remote control device 10 having the protective cover 20 is prevented from activating the buttons on the remote control device when the person presses the front wall 24 of the protective cover over one or more buttons 12 of the remote control device.

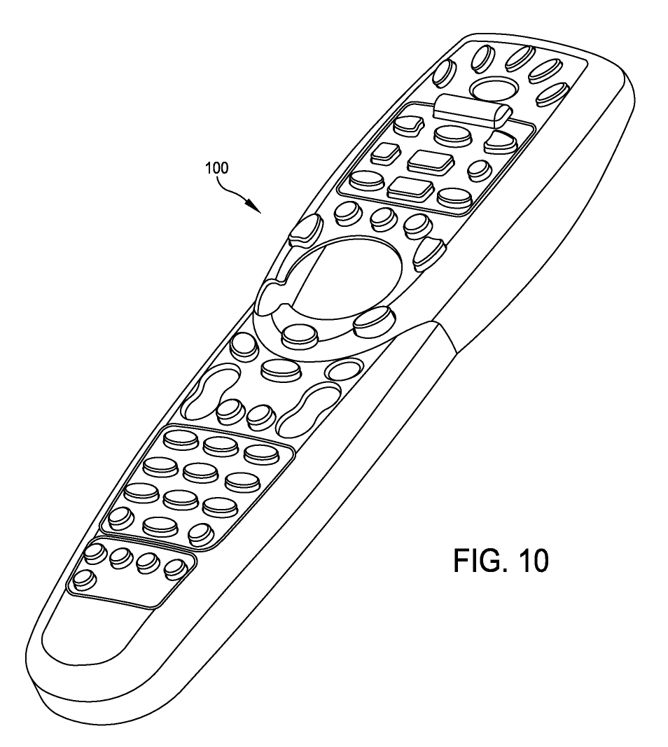

Referring additionally to FIG. 7, the side wall 26 of the rigid skin 22 of the protective cover 20 have several snap-fit connectors, each generally indicated at 30, that are designed to snap-fit an edge 18 of the remote control device 10. Each snap-fit connector 30 is designed to engage the edge 18 of the remote control device 10 to releasably secure the rigid skin 22 to the remote control device. As shown, the protective cover 20 includes eight snap-fit connectors 30 provided along the side wall 26 of the rigid skin 22, with four snap-fit connectors being provided along each side of the rigid skin. As shown, the snap-fit connectors 30 are spaced substantially equidistant from one another to firmly secure the protective cover 20 to the remote control device 10. It should be understood that any number of snap-fit connectors may be provided with the snap-fit connectors being spaced apart from one another a desired distance.

In a certain embodiment, each snap-fit connector 30 includes a body 32 having a hook 34 formed at the end of the body to snap-fit over the edge 18 of the remote control device 10. The body 32 of the snap-fit connector 30 is integrally formed with the side wall 26 and is capable of flexing with respect to the side wall thereby enabling the snap-fit connection to the remote control device 10. During application of the protective cover 20 onto the remote control device 10, the snap-fit connectors 30 flex outwardly with respect to the side wall 26 until the hooks 34 extend over the edge 18 of the remote control device 10. To remove the protective cover 20, outward pressure is applied to one or more of the snap-fit connectors 30 to slip the protective cover off of the remote control device 10.

Since the rigid skin 22 of the protective cover 20 is fabricated from thermoplastic polymeric material, the rigid skin is rigid enough to prevent covered buttons 12 of the remote control device 10 from being pressed but also flexible enough to snap-fit and remove the snap-fit connectors 30 to and from the remote control device. In a preferred embodiment, the rigid skin 22 is fabricated from acrylonitrile butadiene styrene (ABS). In other embodiments, the rigid skin 22 is fabricated from a robust thermoplastic engineered resin, polycarbonate, or another resin in the same family of plastics.

As mentioned herein, the protective cover 20 of embodiments of the disclosure is particularly useful in covering and protecting the remote control device 10 for a remote apparatus embodying a set top box. In a certain embodiment, the openings 28a-28f formed in the rigid skin 22 are configured to provide access to frequently used buttons, such as ON/OFF, CHANNEL UP/DOWN, VOLUME UP/DOWN, GUIDE, LAST, MENU, and/or MUTE. Thus, the openings 28a-28f formed in the front wall 24 of the rigid skin 22 correspond to the locations of these particular buttons. The provision of additional openings can be provided in the rigid skin 22 for embodiments in which access to additional buttons on the remote control device is desired. Similarly, the provision of fewer openings can be provided for embodiments in which access to fewer buttons on the remote control device is desired.

The protective cover 20 can be configured to allow access to any desired button or buttons 12 provided on the remote control device 10. In one embodiment, the rigid skin 22 of the protective cover 20 can be configured with perforations 36 (FIG. 4) around select buttons 12 of the remote control device 10 when applied to the remote control device to enable the operator to remove a portion of the rigid skin 22 to provide access for a particular button or buttons. The perforations 36 surrounding protected buttons 12 on the remote control device 10 are sufficiently strong to enable the rigid skin 22 to protect the covered buttons, thereby preventing covered buttons from being pressed by the operator. The perforations 36 enable that portion of the front wall 24 of the rigid skin 22 to be removed to expose a desired button when the protective cover 20 is applied to the remote control 10. In one embodiment, the operator can remove the perforations 36 with a tool or by hand to expose a certain button or buttons.

In certain embodiments, the protective cover 20 is manufactured of a robust thermoplastic engineered resin, polycarbonate, or another resin in the same family of plastics, which helps prevent accidental damage or breakage should the remote control device 10 be accidentally dropped onto a hardwood floor, tile floor or other hard surface.

Although the attached drawings illustrate a protective cover 20 having certain buttons covered and protected, it should be understood that the protective cover of embodiments of the present disclosure may be configured to cover any number of buttons and configured for any type of remote control design. Also, the protective cover 20 may be configured to overlay the front and the back of the remote control device 10.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

For example, the protective cover 20 can be used for any type of handheld remote control device, including, but not limited to remote controls for televisions, cable boxes, DVD players, tuners, sound systems, audio/visual devices, and the like. The protective cover 20 can be configured to enable access to select buttons of any type of remote control device.

Moreover, the protective cover can include certain modifications to the protective skin. FIG. 8 illustrates a protective cover, generally indicated at 80, of another embodiment. FIG. 9 illustrates a protective cover, generally indicated at 90, of another embodiment. FIG. 10 illustrates a protective cover, generally indicated at 100, of another embodiment. As shown, protective covers 80, 90, 100 are slightly different from one another with modifications particularly directed to the access of certain buttons 12 of the remote control device 10.

For example, the protective cover 80 can be configured to engage a seam that goes around a periphery of the remote control 10 to secure the protective cover to the remote control. The protective cover 80 includes an edge 82 that fits within the seam provided on the remote control 10. Thus, with this embodiment, the provision of snap fit connectors is not required.

Having thus described at least one embodiment of the present disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting. The disclosure's limit is defined only in the following claims and equivalents thereto.

What is claimed is:

1. A protective cover for a remote control device of the type having a plurality of buttons designed to be pressed to perform operations on a remote apparatus, the protective cover comprising a rigid skin configured to be secured to the remote control to cover a front of the remote control, the rigid skin including openings formed therein to selectively reveal certain buttons of the remote control device to be pressed by an operator of the remote control device, the rigid skin being configured to prevent covered buttons from being pressed by the operator.

2. The protective cover of claim 1, wherein the rigid skin is fabricated from thermoplastic polymeric material.

3. The protective cover of claim 2, wherein the rigid skin is fabricated from acrylonitrile butadiene styrene.

4. The protective cover of claim 1, wherein the remote apparatus is a set top box.

5. The protective cover of claim 4, wherein the openings are configured to provide access to frequently used buttons, including ON/OFF, CHANNEL UP/DOWN, VOLUME UP/DOWN, GUIDE, LAST, MENU and/or MUTE.

6. The protective cover of claim 1, wherein the rigid skin is fabricated from a robust thermoplastic engineered resin, polycarbonate, or another resin in the same family of plastics.

7. The protective cover of claim 1, wherein the rigid skin includes at least one side having at least one connector that is designed to engage an edge or a seam of the remote control device.

8. The protective cover of claim 7, wherein the at least one connector includes a snap-fit connector having an edge that is designed to engage the edge of the remote control device.

9. The protective cover of claim 1, wherein the rigid skin is configured with perforations around select buttons of the remote control device to enable the operator to remove a portion of the rigid skin to provide access for a particular button or buttons.

10. The protective cover of claim 1, wherein the rigid skin includes a front that conforms to the front of the remote control device and sides that conform to sides of the remote control device.

11. The protective cover of claim 10, wherein the rigid skin includes at least one side having at least one connector that is designed to engage an edge or a seam of the remote control device.

12. The protective cover of claim 11, wherein the at least one connector includes a snap-fit connector having an edge that is designed to engage the edge of the remote control device.

13. The protective cover of claim 10, wherein the front of the rigid skin is molded to show locations of buttons of the remote control device covered by the rigid skin.

14. A protective cover for a remote control device of the type having a plurality of buttons designed to be pressed to perform operations on a remote apparatus, the protective cover comprising a rigid skin configured to be secured to the remote control to cover a front of the remote control, the rigid skin including a front having openings formed therein to selectively reveal certain buttons of the remote control device to be pressed by an operator of the remote control device, the rigid skin being configured to prevent covered buttons from being pressed by the operator, the rigid skin further including sides that conform to sides of the remote control device, the sides being configured to releasably secure the rigid skin to the remote control device.

15. The protective cover of claim 14, wherein the sides of the rigid skin has at least one connector that is designed to engage an edge or a seam of the remote control device.

16. The protective cover of claim 15, wherein the at least one connector has an edge that is designed to engage the edge or the seam of the remote control device.

17. The protective cover of claim 14, wherein the front of the rigid skin is molded to show locations of buttons of the remote control device covered by the rigid skin.

18. The protective cover of claim 14, wherein the rigid skin is fabricated from thermoplastic polymeric material.

19. The protective cover of claim 18, wherein the rigid skin is fabricated from acrylonitrile butadiene styrene.

20. The protective cover of claim 14, wherein the remote apparatus is a set top box, and the openings of the front of the rigid skin are configured to provide access to frequently used buttons, such as ON/OFF, CHANNEL UP/DOWN, VOLUME UP/DOWN, GUIDE, LAST, MENU and/or MUTE.
